(19) United States
(12) Patent Application Publication
(10) Pub. No.: US 2026/0051261 A1
(43) Pub. Date: Feb. 19, 2026

(54) AUTOMATED EXECUTIVE FUNCTION COACHING PLATFORM

(71) Applicant: Hotkeys Holding LLC, Highland, MD (US)

(72) Inventors: Nithin Krishna, Highland, MD (US); Nandana Ratheesh, Highland, MD (US); Anjali Krishna, Highland, MD (US)

(73) Assignee: Hotkeys Holding LLC, Highland, MD (US)

(21) Appl. No.: 19/301,153

(22) Filed: Aug. 15, 2025

Related U.S. Application Data
(60) Provisional application No. 63/684,554, filed on Aug. 19, 2024.

(51) Int. Cl. G09B 7/04; G06Q 50/20

(52) U.S. Cl. CPC G09B 7/04; G06Q 50/20

(57) ABSTRACT

A system for an automated and on-demand executive function coaching platform for the development of executive functions and STEM learning in school-aged children, and specifically for children with learning disabilities. The system includes a generative artificial intelligence module to provide automated coaching, wherein the coaching includes lessons, programs, activities, and/or assessments, with an easy to integrate application program interface. The system may also include motivational interviewing, gamification of learning, and a rewards system for the completion of coaching lessons.

### CROSS REFERENCES TO RELATED APPLICATIONS

This application is related to and claims priority from the following U.S. patent applications. This application claims priority to and the benefit of U.S. Provisional Ser. No. 63/684,554 , filed Aug. 19, 2024, which is incorporated herein by reference in its entirety.

### BACKGROUND OF THE INVENTION

### 1. Field of the Invention

The present invention relates to an automated online development and coaching platform, and more specifically to an automated executive function coaching platform.

### 2. Description of the Prior Art

It is generally known in the prior art to provide educational development platforms.

Prior art patent documents include the following:
US Patent Publication No. 2011/0229862 for Method and apparatus for training brain development disorders by inventor Parikh, filed Feb. 22, 2011, and published Sep. 22, 2011, is directed to the field of education of human subjects, and more specifically to a computer program for training the brain development disorder where in human subjects are impaired of social interaction and communication. The program delivers animated content to the subject and varies the size, clarity, colors, background images, animated characters, sound with animation, method of instructions, so they would be more easily distinguished by the subject and thereby gradually improves the subject's neurological processing and memory of the elements through repetitive stimulation. Thus the system, method and apparatus of the present invention maximizes the effectiveness and efficiency of learning by adding a reward delivery system to deliver the object of the student's interest upon achieving the goal set by the trainer. The system includes modules configuration system, user validation system, content delivery system, user response/input system, monitoring system and feedback system. The configuration engine includes a progress module which monitors a user's performance on any of learn, review and test modules and changes the future lessons based on the monitored performance. The content delivery system includes help or instructions screen to provide assistance with any of the learning lessons.
U.S. Pat. No. 11,468,788 for System and method for teaching curriculum as an educational game by inventors Bedor, et al., filed Aug. 14, 2018, and issued Oct. 11, 2022, is directed to an educational game (and learning management system and methods pertaining to the same) that can be configured for the effective teaching of advanced educational curriculum, such as STEM subjects for high school and above. The educational game is configured to integrate social context, real scientific principles and strategic tradeoffs within game mechanisms. This covert teaching and testing environment promotes exploration, individualized discovery, repeat engagement, and systems thinking and planning skills. The educational game can be dynamically and procedurally generated.
US Patent Publication No. 2019/0244127 for Adaptive teaching system for generating gamified training content and integrating machine learning by inventors Amado, et al., filed Feb. 8, 2019, and published Aug. 8, 2019, is directed to an improved system and method for generating gamified training content using multimodal human-machine interfaces controlled by an adaptive backend training system. Such a system can include a gamification engine working in conjunction with a machine learning engine for adaptively updating or restructuring database elements by analyzing existing data and applying external training data. Training content can thus be progressively optimized for various users, groups, and training contexts as the system adapts.
US Patent Publication No. 2019/0388787 for Method and system for scenario selection and measurement of user attributes and decision making in a dynamic and contextual gamified simulation by inventors Padmanabhan, et al., filed Jun. 10, 2019, and published Dec. 26, 2019, is directed to allowing organizations to set up, and its users to experience, dynamic, realistic gamified simulations in a cost-and time-efficient manner, as a means of iteratively assessing and developing individuals'work-focused decision making. It also enables measurement of user attributes and the process of decision making involved at work, through the process of experiencing such simulations. By closely mirroring, or realistically simulating the way data changes with users'decisions or with events external or internal to the organization, the invention is able to faithfully reconstruct the work environment of the user, generate true-to-life responses and unobtrusively measure behavior under various simulated situations. Overcoming existing challenges involved in measuring personal attributes (such as leadership competencies or decision making) in dynamic simulations, the invention allows assignment of scores to users regardless of the specific dynamic and idiosyncratic stimuli they are exposed to within the simulation experience, using the invention's method and system.
US Patent Publication No. 2022/0273985 for Interactive ai coaching-based musculoskeletal exercise and rehabilitation training system and method by inventors Jeong, et al., filed Feb. 23, 2022, and published Sep. 1, 2022, is directed to an interactive AI coaching-based musculoskeletal exercise and rehabilitation training system, including: a user state information measurement unit connected to a cloud server through a wired or wireless network and measuring state information, the state information being information about a user's exercise posture or physical condition; a display panel displaying necessary information to a user during exercise based on the state information measured by the user state information measurement unit; an exercise unit allowing a user to perform a resistance exercise or a balance exercise; a coaching engine receiving and analyzing the state information measured by the user state information measurement unit during a user's exercise using the exercise unit and providing AI-based interactive coaching information to a user through the display panel; and an expert terminal providing rehabilitation service information to a user exercising using the exercise unit through the display panel in parallel with the coaching engine.
US Patent Publication No. 2022/0319181 for Artificial intelligence (ai)-based system and method for managing education of students in real-time by inventors Kanuganti, et al., filed Apr. 6, 2022, and published Oct. 6, 2022, is directed to a system and method for managing education of students in real-time. The method includes receiving learning data associated with online mode and offline mode of classroom from one or more data capturing devices and media streams and detecting a set of activities. The method further includes classifying the determined set of activities and determining a set of contextual parameters corresponding to the detected set of activities. Further, the method includes identifying one or more learning gaps in one or more students based on the learning data, the set of activities and the set of contextual parameters by using an education management-based AI model in real-time and outputting the set of activities, the set of contextual parameters and the one or more learning gaps on user interface screen of one or more electronic devices.
U.S. Pat. No. 11,791,026 for Cloud-based healthcare diagnostics and treatment platform by inventor Fung, filed Mar. 22, 2023, and issued Oct. 17, 2023, is directed to a cloud-based healthcare diagnostic and treatment platform capable of making non-invasive healthcare diagnostics and treatment recommendations based on data captured from combinations of physical activity and mental activity. In an embodiment, the system and method comprise a healthcare diagnostics and treatment module comprising a HIPPA-compliant security gateway, an AI-assisted healthcare diagnostics module, and an alert and treatments module. The HIPPA-compliant security gateway separates out health-related data from streams of data which may include other data such as game data, provides the health-related data to the AI-assisted healthcare diagnostics module which performs diagnoses of the health-related data using machine learning algorithms, and provides the diagnoses to the alert and treatments module which generates alerts and treatments based on the diagnoses.
US Patent Publication No. 2022/0415478 for Systems and methods for mental exercises and improved cognition by inventors Simpson, et al., filed Jun. 16, 2022, and published Dec. 29, 2022, is directed to systems and methods for improved cognition via mental exercises. In some embodiments, contextual information regarding the user and her environment are collected. Subsequently, the user is presented with a cognitive task, wherein the cognitive task includes a stimuli and the task specifies a desired response to the stimuli. Feedback is then collected from the user. Additionally the exercise results are assessed. The feedback, results and context information are then all aggregated in order to generate guidance for the user of the system. Guidance may be determined by a rule based system, via AI modeling, or by some combination of the two.
US Patent Publication No. 2023/0301570 for Non-invasive portable device and method to assess mental conditions by inventor Anson, filed Apr. 11, 2023, and published Sep. 28, 2023, is directed to a system of hardware and software that captures and processes in real time biometric data of patient responses and reactions to tablet-based valenced pictorial stimuli to facilitate diagnosis of mental health conditions of the patient including Autism Spectrum Disorder (ASD), Attention-Deficit Hyperactivity Disorder (ADHD), Traumatic Brain Injury (TBI), and Post-Traumatic Stress Disorder (PTSD) is provided. Via transparent, non-invasive biometrics induced by pictorial stimuli, the system removes potentially threatening testing instrument characteristics that can invalidate authentic assessment. The system will mitigate or remove other threats to assessment validity including subjective judgments as well as bias on the part of the examiners who are completing subjective surveys. The biometric assessment is incorporated within a variety of engaging game formats that appeal to males and females of nearly any age that speak a variety of languages and encompass a wide spectrum of demographics and ethnicities.
US Patent Publication No. 2023/0162835 for System and method for collecting and analyzing mental health data using computer assisted qualitative data analysis software by inventor Ward, filed Nov. 23, 2022, and published May 25, 2023, is directed to a gamified computerized mental health assessment and tracking system. The system comprises an input device with a user interface that provides the patient a mechanism to supply answers and reactions to prompts and queries with a focus on mental disorders. Artificial intelligence performs data analysis on the user's answers and reactions and generates a report transmitted to a third party with information representing the user's mental health condition.
US Patent Publication No. 2023/0285806 for Systems and methods for intelligent fitness solutions by inventors Webster, et al., filed Mar. 8, 2023, and published Sep. 14, 2023, is directed to systems and methods for recognizing movements of a moving body and presenting multimedia content according to the movements to provide instructional learning. As an example of the systems and methods, movement recognition is provided that generates a body object stream from raw data of movements, recognizes techniques for the movements based on the body object stream, and assesses a performance of the techniques. A coaching intelligence is provided that fetches and communicates multimedia content descriptive of the techniques according to the performance and based on one or more configuration files defining coaching strategies and a mapping of multimedia content. The systems and methods provided herein can be leveraged for recognition of human movements in a fitness environment for provisioning of multimedia content consumable for instructional learning of techniques performed as part of a fitness or exercise routine.
U.S. Pat. No. 11,625,615 for Artificial intelligence advisory systems and methods for behavioral pattern matching and language generation by inventor Neumann, filed Jul. 3, 2019, and issued Apr. 11, 2023, is directed to an artificial intelligence system for behavioral pattern matching and language generation includes at least a server. The system includes a behavior modification module operating on the at least a server, wherein the behavior modification module is designed and configured to receive at least a request for a behavior modification and generate a behavior modification model as a function of the at least a request for behavior modification. The system includes an artificial intelligence advisor operating on the at least a server, wherein the artificial intelligence advisor is configured to receive at least a user input from a user client device, generate at least a textual output using the behavior modification model and the at least a user input, and transmit the at least a textual output to the user client device.
US Patent Publication No. 2023/0230491 for Skill journey feature and live assessment tool on a learning platform by inventor Nedivi, filed Jan. 24, 2023, and published Jul. 20, 2023, is directed to a method and system comprising an adaptive learning platform having a backend component for managing 3D lessons for display on an interface of a user device. The platform facilitates in creating a Skills Journey with live assessment.
US Patent Publication No. 2023/0395235 for System and method for delivering personalized cognitive intervention by inventors Vithalsingh, et al., filed Apr. 21, 2023, and published Dec. 7, 2023, is directed to a computational personalized cognitive therapeutic system for treating patients with Mild Cognitive Impairment, Alzheimer's Disease, dementia and related conditions. The system includes a patient clinical database, a data aggregation layer and data pre-processor module, a digital cognitive therapy delivery module, a cognitive analytics engine, and a personalised cognitive platform configured to personalize a personalised cognitive digital therapy model. The personalised cognitive digital therapy model defines specific digital treatments to be delivered to the patient using the digital cognitive therapy delivery module each with a different mechanism of action. A range of digital cognitive biomarkers are collected along with behavioural and physiological biomarkers from wearable and medical devices which are processed by the cognitive analytics engine and uses AI/ML methods which are configured to estimate metrics and generate alerts. The metrics are used to assess treatment progress and then personalize the personalised cognitive digital therapy model for the patient including adjustment of digital therapies and medication. Alerts may be generated if adverse side effects are observed. This process is iteratively repeated to provide improved treatment over time.
US Patent Publication No. 2024/0185880 for Systems and methods for emotion detection, prediction, annotation, and coaching by inventors Samant, et al., filed Dec. 2, 2022, and published Jun. 6, 2024, is directed to a system that performs emotion detection, prediction, and coaching system. The system includes a media feature extractor, which extracts features from different media modalities, a perceiver module which detects or predicts emotional response for a given audience, a coaching module that generates context-based, personalized coaching in the form of commentary, retrospective analysis, tips kudos, events, and scores. The intermediate results, like media feature, perceiver output, and context, are stored in an emotion association database, which can be used as reference data by the system.
U.S. Pat. No. 11,392,856 for Methods and systems for an artificial intelligence support network for behavior modification by inventor Neumann, filed Aug. 31, 2020, and issued Jul. 19, 2022, is directed to an artificial intelligence behavior modification support system including a diagnostic engine operating on the at least a server and configured to receive at least a biological extraction from a user and generate at least a request for a behavior modification. The system includes an influencer module designed and configured to generate at least a request for an influencer as a function of the at least a request for a behavior modification. The system includes a client interface module designed and configured to transmit the at least a request for an influencer to at least a client device.
US Patent Publication No. 2023/0401969 for Speech and language correcting system by inventors Samuels, et al., filed Jun. 8, 2022, and published Dec. 14, 2023, is directed to a computer-implemented automated speech and language system to assist in correcting speech and language disorders in children and adults. The system has a device connected to a camera and a processor. The system also includes a non-transitory machine-readable medium comprising instructions stored therein, which when executed by the processor, cause the processors to perform operations. The operations performed by the non-transitory machine-readable medium are accessing or creating a user profile, selecting an exercise to be performed by the user, detecting the user's face and alignment in front of the camera, determining a face key point data, determining an actual data model based on the face key point data, determining a reference model based on a correct performance of the exercise scaled for physical characteristics of the user, comparing the actual data model with the reference model, interpreting whether a result of the comparison between the actual data model and the reference model is within predetermined parameters; and providing a feedback based on the interpretation.
US Patent Publication No. 2022/0117548 for System and methods for custom adjustments of a learning system according to an individual's cognition level by inventor Botrashvili, filed Oct. 18, 2021, and published Apr. 21, 2022, is directed to a method and system for improving learning capabilities and concentration.
US Patent Publication No. 2021/0043106 for Technology based learning platform for persons having autism by inventors Kotra, et al., filed Jul. 22, 2020, and published Feb. 11, 2021, is directed to providing a technology based learning platform for persons having autism. According to an aspect, skills of interest for a user are identified. The user is then aided in acquiring each of the identified skills. The progress of the user for each skill is monitored and a dashboard is provided to display the progress of the user for the skills.
US Patent Publication No. 2012/0021390 for Method and system for developing language and speech by inventor Dodd, filed Jul. 26, 2011, and published Jan. 26, 2012, is directed to a method, system and apparatus for developing concepts, language and speech in language learning disabled and generally learning disabled subjects. The approach attempts to build associations between the various implementations of language, namely, visual, oral, aural and written language within the subject. The technique utilizes the subject's main strengths, often the visual sense and develops language by building on that strength, gradually progressing to spoken and heard language. Graphically rich content is sued to convey the concepts to the subject. The disclosed techniques may be implemented using a computer program.
U.S. Pat. No. 10,699,271 for Method and apparatus for advancing through a deck of digital flashcards by inventor Shea, filed Nov. 12, 2015, and issued Jun. 30, 2020, is directed to parents and entities incentivizing students to learn using pledges of cash, goods, and services. Students earn incentivized rewards by interacting with lessons on a digital computing device, such as a desktop computer, notebook, tablet, or “smart phone.” The lessons may include digital flash cards, text, pictures, figures, audio and video recordings ranging from classroom lectures, to classical music, to animation of scientific principles. In flashcard embodiments, the accuracy of each answer is recorded on a histogram corresponding to a particular flashcard, or the principles taught therein. The application generates performance metrics from histogram data. The performance metrics are used to generate control parameters that control the frequency and order flashcard presentation. Statistical analysis, adaptive learning and/or artificial intelligence programs refine the control parameters governing flashcard review, thereby optimizing the functionality. As a student satisfies various performance metrics and/or courseware requirements, incentives are released to the student.
U.S. Pat. No. 10,311,645 for Methods and systems for treating autism by inventors Ravindran, et al., filed Oct. 12, 2017, and issued Jun. 4, 2019, is directed to a method for treating autism. The method includes presenting to affected subjects therapeutic content in the form of images or video in a virtual or augmented reality system and monitoring in real time the behaviors and responses of the subject to the therapy. The virtual or augmented reality system may further include audio, and the monitoring of the therapy may be achieved using one or more tracking sensors, such as a camera.
U.S. Pat. No. 11,210,968 for Behavior-based interactive educational sessions by inventors Clevenger, et al., filed Sep. 18, 2018, and issued Dec. 28, 2021, is directed to a computer system interacting with a user with a behavioral state. An activity performed by an entity with a behavioral state is determined. A virtual character corresponding to the entity and performing the determined activity of the entity is generated and displayed. A mental state of the entity responsive to the virtual character is detected. In response to detection of a positive mental state of the entity, one or more natural language terms are provided to the entity corresponding to the activity performed by the virtual character. Embodiments of the present invention further include a method and program product for interacting with a user with a behavioral state in substantially the same manner described above.
U.S. Pat. No. 9,704,103 for Digital companions for human users by inventors Suskind, et al., filed Dec. 16, 2014, and issued Jul. 11, 2017, is directed to a succession of conversations facilitated between a user of a device and a non-human companion portrayed on the device, to develop a relationship between the user and the non-human companion over a time period that spans the successive conversations. The relationship is developed between the user and the non-human companion to cause a change in a state of the user over the time period. A conversation is facilitated by presenting a segment of speech of the non-human companion to the user and detecting a segment of speech of the user, the segments including a portion of the conversation. At the device, information is received from an intelligent agent about a next segment of speech to be presented to the user, as determined by the intelligent agent based on intelligent processes applied to the segment of speech of the user and to the change in state to be caused.
US Patent Publication No. 2023/0419434 for Personalized adaptive education course adapting to neurodiversity considerations in online learning by inventors Keen, et al., filed Jun. 23, 2022, and published Dec. 28, 2023, is directed to tailoring a set of course material of an online educational course to provide one or more learning supports necessary for a student with a neurodivergent-classified condition to succeed, a processor receives a request from a user to tailor the set of course material. A processor identifies one or more neurodivergent needs of the user based on a first set of data gathered from a database. A processor observes the user complete an unmodified version of the online educational course in real-time to identify one or more additional neurodivergent needs of the user. A processor determines one or more preferences of the user. A processor generates a set of recommendations on how to tailor the set of course material. A processor creates a personalized user interface based on the set of recommendations for the user to access a tailored set of course material.
US Patent Publication No. 2021/0174933 for Social-emotional skills improvement by inventors Beaumont, et al., filed Dec. 7, 2020, and published Jun. 10, 2021, is directed to a method for improving social-emotional skills in a biological subject, including acquiring subject data indicative of a subject response to one or more social cues, deriving metrics from the subject data, including at least one response metric indicative of the subject response, applying the one or more metrics to a computational model to generate a skill state indicator relating to a social-emotional skills state of the subject, the at least one computational model embodying a relationship between social-emotional skill states and the one or more metrics, wherein the at least one computational model is obtained by applying machine learning to reference metrics derived from reference subject data measured for one or more reference subjects and using the skill state indicator to perform a therapeutic intervention to thereby improve the social-emotional skills of the subject.
U.S. Pat. No. 12,211,511 for System that conducts and evaluates oral question-and-answer sessions using artificial intelligence by inventor Sandrew, filed Oct. 7, 2024, and issued Jan. 28, 2025, is directed to an artificial intelligence system that conducts an oral question-and-answer session with a single respondent to achieve an educational outcome, such as reviewing material to reinforce ideas or to prepare the respondent for future tests or events, or evaluating the respondent's knowledge or communication skills. The system may use an artificial intelligence engine that can understand and generate natural language, such as a large-language model like ChatGPT™. Text-to-speech and speech-to-text converters may be coupled to the AI engine to enable the system to communicate directly with the respondent using spoken language. The system may provide an interface for entry of session information such as background information on topics and the type of questioning that should be used during the session. The respondent may be given multiple attempts to answer a question and to select the best response, and the system may provide an evaluation and feedback after each response.
U.S. Pat. No. 10,467,919 for Systems and methods or AI-based student tutoring by inventor Fuka, filed Dec. 4, 2017, and issued Nov. 5, 2019, is directed to dynamic assessment by an expert system software (ESS) module. The ESS module may determine a minimum set of diagnostic questions to identify a student's strengths and/or weaknesses for a given subject matter. Each diagnostic question may be a unique question variant generated from a dynamic question template. The ESS module may automatically and dynamically build a personal lesson plan that includes lessons on topics of the subject matter that the student has not mastered. The ESS module may dynamically modify the personal lesson plan to change a lesson and/or add lesson(s) considered by the ESS module as necessary for the student to master the subject matter. Given the ESS module's knowledge on various components of a question such as equation(s) used to produce a correct answer to the question, the ESS module may generate image(s), customized hint(s), customized explanation(s), and/or examine student solutions in step-by-step fashion.

### SUMMARY OF THE INVENTION

The present invention relates to an automated online development and coaching platform.

It is an object of this invention to provide a generative AI coaching platform for executive function and cognitive development.

In one embodiment, the present invention includes a system for automated executive function coaching, including a remote server including at least one computer processor and a memory, a foundational artificial intelligence (AI) module, a customized AI module, and a user device, wherein the foundational AI module is a pre-trained AI module, wherein the foundational AI module is operable to be further trained with training data, wherein the customized AI module is generated based on the further training of the foundational AI module, wherein the customized AI module is operable to conduct an assessment of at least one user, wherein the customized AI module is operable to automatically analyze results of the assessment of the at least one user, wherein the customized AI module is operable to automatically generate an individualized coaching plan for the at least one user based on the results of the assessment of the at least one user, and wherein the customized AI module is operable to conduct at least one coaching session through the user device, wherein the at least one coaching session includes at least one of a program, an assessment, and/or an activity, wherein the program, the assessment, and/or the activity is directed to executive function development of the at least one user.

In another embodiment, the present invention includes a method for automated executive function coaching, including, training a pretrained foundational artificial intelligence (AI) module with training data, forming a customized AI module by the training of the foundational AI module, conducting an assessment of at least one user by the customized AI module, automatically analyzing results of the assessment of the at least one user by the customized AI module, automatically generating an individualized coaching plan for the at least one user based on the results of the assessment by the customized AI module, and conducting a coaching session through a user device by the customized AI module, wherein the coaching session includes at least one of a program, an assessment, and/or an activity, and wherein the program, the assessment, and/or the activity is directed to executive function development of the at least one user.

In yet another embodiment, the present invention includes a system for automated executive function coaching, including, a remote server including at least one computer processor and a memory, a foundational artificial intelligence (AI) module, a customized AI module, and a user device, wherein the foundational AI module is a pre-trained AI module, wherein the foundational AI module is operable to be further trained with training data, wherein the customized AI module is generated based on the additional training of the foundational AI module, wherein the system is operable to receive and process data uploaded from the user device, wherein the customized AI module is operable to conduct an assessment of the at least one user, wherein the customized AI module is operable to automatically analyze results of the assessment of the at least one user, wherein the customized AI module is operable to automatically generate an individualized coaching plan for the at least one user based on the results of the assessment of the at least one user, wherein the individualized coaching plan includes at least one lesson plan, wherein the at least one lesson plan is used in at least one coaching session, and wherein the customized AI module is operable to conduct the at least one coaching session through the user device, wherein the at least one coaching session includes at least one of a program, an assessment, an activity, and/or a game, wherein the program, the assessment, the activity, and/or the game is directed to executive function development of the at least one user.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a is a block diagram of the steps performed by a system of the present invention for training an artificial intelligence (AI) module according to one embodiment of the present invention.

FIG. 2 is a is a block diagram of the steps performed by a system of the present invention for training an AI module according to one embodiment of the present invention.

FIG. 3 illustrates an overview of an AI module of the present invention according to one embodiment of the present invention.

FIG. 4A is a is a block diagram of the steps performed by a system of the present invention for uploading data according to one embodiment of the present invention.

FIG. 4B is a block diagram of the steps performed by a system of the present invention for uploading data according to one embodiment of the present invention.

FIG. 4C is a block diagram of the steps performed by a system of the present invention for uploading data according to one embodiment of the present invention.

FIG. 5 is a schematic diagram of a hierarchical database organization scheme according to one embodiment of the present invention.

FIG. 6A is a block diagram of the steps performed by a system of the present invention for adding new fields data according to one embodiment of the present invention.

FIG. 6B is a block diagram of the steps performed by a system of the present invention for adding new fields data according to one embodiment of the present invention.

FIG. 6C is a block diagram of the steps performed by a system of the present invention for adding new fields data according to one embodiment of the present invention.

FIG. 7 illustrates the data structure of an assessment of the system of the present invention according to one embodiment of the present invention.

FIG. 8 is a schematic diagram of a system of the present invention.

### DETAILED DESCRIPTION

The present invention is generally directed to an automated online development and coaching platform.

In one embodiment, the present invention includes a system for automated executive function coaching, including a remote server including at least one computer processor and a memory, a foundational artificial intelligence (AI) module, a customized AI module, and a user device, wherein the foundational AI module is a pre-trained AI module, wherein the foundational AI module is operable to be further trained with training data, wherein the customized AI module is generated based on the further training of the foundational AI module, wherein the customized AI module is operable to conduct an assessment of at least one user, wherein the customized AI module is operable to automatically analyze results of the assessment of the at least one user, wherein the customized AI module is operable to automatically generate an individualized coaching plan for the at least one user based on the results of the assessment of the at least one user, wherein the customized AI module is operable to conduct at least one coaching session through the user device, wherein the at least one coaching session includes at least one of a program, an assessment, and/or an activity, wherein the program, the assessment, and/or the activity is directed to executive function development of the at least one user, wherein the customized AI module is operable to automatically generate at least one report concerning progress through the at least one coaching session of the at least one user, wherein the customized AI module is operable to be trained with recorded simulated coaching sessions, wherein the customized AI module is operable to be refined with direct preference optimization (DPO), wherein the system further includes a supervisory artificial intelligence (AI) agent, and wherein the supervisory AI agent is operable to review an output of a finished coaching session and produce a score of the finished coaching session, wherein the system is operable to receive and process data uploaded by from the user device, wherein the customized AI module is operable to automatically generate a lesson plan based on the assessment of the at least one user, wherein the lesson plan is used in the at least one coaching session, and wherein the at least one coaching session further includes at least one game.

In another embodiment, the present invention includes a method for automated executive function coaching, including, training a pretrained foundational artificial intelligence (AI) module with training data, forming a customized AI module by the training of the foundational AI module, conducting an assessment of at least one user by the customized AI module, automatically analyzing results of the assessment of the at least one user by the customized AI module, automatically generating an individualized coaching plan for the at least one user based on the results of the assessment by the customized AI module, conducting a coaching session through a user device by the customized AI module, wherein the coaching session includes at least one of a program, an assessment, and/or an activity, and wherein the program, the assessment, and/or the activity is directed to executive function development of the at least one user, further comprising the customized AI module automatically generating at least one report concerning progress through the at least one coaching session of the at least one user, further comprising training the customized AI module with recorded simulated coaching sessions, further comprising refining the customized AI module with direct preference optimization (DPO), further comprising a supervisory AI agent reviewing an output of a finished coaching session and producing a score of the finished coaching session, further comprising receiving and processing data uploaded from the user device, and further comprising the customized AI module automatically generating a lesson plan based on the assessment of the at least one user, wherein the lesson plan is used in the coaching session.

In yet another embodiment, the present invention includes a system for automated executive function coaching, including, a remote server including at least one computer processor and a memory, a foundational artificial intelligence (AI) module, a customized AI module, and a user device, wherein the foundational AI module is a pre-trained AI module, wherein the foundational AI module is operable to be further trained with training data, wherein the customized AI module is generated based on the additional training of the foundational AI module, wherein the system is operable to receive and process data uploaded from the user device, wherein the customized AI module is operable to conduct an assessment of the at least one user, wherein the customized AI module is operable to automatically analyze results of the assessment of the at least one user, wherein the customized AI module is operable to automatically generate an individualized coaching plan for the at least one user based on the results of the assessment of the at least one user, wherein the individualized coaching plan includes at least one lesson plan, wherein the at least one lesson plan is used in at least one coaching session, wherein the customized AI module is operable to conduct the at least one coaching session through the user device, wherein the at least one coaching session includes at least one of a program, an assessment, an activity, and/or a game, wherein the program, the assessment, the activity, and/or the game is directed to executive function development of the at least one user, wherein the system is operable to receive visual data from a camera of the user device, wherein the system is operable to track eye movements of the at least one user based on the visual data, wherein the customized AI module is operable to automatically generate at least one report concerning progress through the at least one coaching session of the at least one user, wherein the system further includes a supervisory AI agent, and wherein the supervisory AI agent is operable to review an output of a finished coaching session and produce a score of the finished coaching session, and wherein the customized AI module is operable to be refined with direct preference optimization (DPO).

None of the prior art discloses an automated and on-demand executive function coaching platform, specifically targeting executive function development and STEM learning of children with learning disabilities.

Executive functions are the basic self-management skills that allow individuals to set and accomplish goals and tasks, and more broadly, to get things done. Examples of such executive functions include planning, organizing, self-management, time management, inhibition, focusing, recovering, brainstorming, working memory, self-advocacy, initiating tasks, visualizing outcomes, evaluating priorities, managing emotions, and taking initiative. Having these skills equips children and students with the necessary tools to have better educational and social outcomes. However, executive functions, and the tools for developing such functions, are generally not taught in school. Thus, children that struggle with any executive function may struggle academically in school and socially and the child may struggle to further develop the executive function. This is especially true for students with learning disabilities or other mental health challenges, such as attention deficit hyperactivity disorder (ADHD), traumatic brain injury, anxiety, depression, dyslexia, Tourette's syndrome, and/or obsessive-compulsive disorder (OCD).

ADHD is a common neurodevelopmental disorder marked by an ongoing pattern of inattention, hyperactivity, and/or impulsivity, all of which interfere with executive functioning and/or development. Inattention refers to an individual struggling to stay focused on a task at hand. Hyperactivity refers to an individual's need to constantly move around, including fidgeting, tapping, or talking. Impulsivity refers to an individual acting without thinking and struggling with self-control. Inattention, hyperactivity, and/or impulsivity, alone, or in combination, present difficulties for children in school and at home, making it more difficult for children with ADHD to accomplish tasks and goals.

Students with ADHD often struggle with science, technology, engineering, and mathematics (STEM) subjects, due to difficulty focusing, controlling impulses, and regulating behavior, all which stem from executive functions. Additionally, over 65% of students with ADHD struggle with comorbidities, including depression, anxiety, and learning disorders, all of which affect academic performance, family life, and social life.

Prescription drugs are often used to treat symptoms of ADHD, such as hyperactivity and impulsivity, however, these prescription drugs can be addictive and are often associated with troubling side effects, such as decreased appetite, delayed growth, sleep issues, headaches, nausea, tics, mood changes, and irritability. Additionally, ADHD can be treated with various therapies, including behavior therapy, anger management, counseling psychology, family therapy, and/or support groups. However, ADHD may impose a significant financial burden on families, healthcare systems, and schools, as medication and therapy costs continue to climb.

Executive function coaching has become increasingly popular in recent years, specifically for students with ADHD to develop the necessary executive functions to succeed in school. Executive function coaching involves teaching people, mainly children/students, self-management skills, resulting in learning how to successfully navigate the challenges of school and adult life by developing executive functions. Executive function coaching encompasses skills including organization, time management, planning, and enhances intrinsic motivation, and overall providing tactical training to compensate for executive function deficits.

Motivational interviewing is a method of counseling that helps people find the internal motivation to change their behavior. Unlike traditional counseling methods, motivational interviewing includes a clinician assisting the client in changing their behavior by engaging in change talk, which evokes the client's motivation to make changes. Change talk generally refers to a statement indicating a client's consideration of, motivation for, or commitment to change. Thus, in motivational interviewing, the clinician seeks to guide a client to expressions of change talk as the pathway to motivation and change. Combining executive function coaching and motivational interviewing techniques can result in improved intrinsic motivation, as well as managed stress and anxiety levels.

There are eleven executive function categories. Emotional control involves the ability to manage emotions to achieve goals, complete tasks, and control or direct behavior. Sustained attention involves the capacity to maintain attention to a situation or task, despite distractibility, fatigue, or boredom. Response inhibition refers to the ability to control one's responses to stimulation or distractions, including the capacity to think before an individual acts, the ability to resist the urge to say or do something, and allowing an individual to evaluate a situation and how their actions may affect the situation. Working memory includes the ability to hold information in memory while completing tasks, incorporating the ability to draw on past learning or experience and apply those to the situation at hand. Task initiation involves the ability to begin projects without undue procrastination, in an efficient or timely manner. Cognitive flexibility includes the ability to revise plans in the face of obstacles, setbacks, added information, or mistakes, and adapt to changing conditions. Organization refers to the ability to create and maintain systems to keep track of information or materials. Planning and prioritizing involve the ability to consider what needs to be accomplished and in what order. Time management refers to the capacity to estimate, allocate, and spend time wisely. Goal-directed persistence involves the capacity to set and follow through on a goal. Metacognition includes the ability to see the bigger picture, including self-reflection.

Traditional executive function coaching takes place within in-person clinics, which require parents to transport and pay for their child to attend coaching sessions. Many families cannot access these interventions due to various barriers including cost, time, and a shortage of mental health professionals. Additionally, this type of traditional in-person session coaching only provides coaching during the specific set sessions, requiring constant and regular attendance by a child. This presents an additional hardship for children where unexpected events such as scheduling conflicts and/or illness cause a child to miss a session and thus be behind in their coaching, putting the child at a disadvantage. Moreover, intrinsic motivation is often a large problem with clinic-based coaching, because children may only excel with constant external monitoring during the sessions. Once the session is over, children can struggle with intrinsic motivation, because they do not have the constant guidance from the coach. Thus, what is needed is a platform for broader and convenient executive function coaching sessions that can be performed outside of a clinic, providing for improved adherence to treatments and superior outcomes over traditional in-clinic coaching.

Additionally, executive function coaching can induce a financial barrier for children, as sessions generally costs between $200 and $800 per session, and insurance providers generally do not cover the coaching. This can place a significant financial burden on parents seeking coaching for their children and could result in a barrier for students that need coaching, but whose parents cannot afford such a hefty coaching bill. Thus, there is also a need for a more cost-effective coaching platform for children to develop executive functions.

To meet these unmet needs, the system present invention provides an online platform to provide automated and on-demand executive function coaching, including motivational interview-based techniques and gamification features, and utilizing an artificial intelligence module, to help students with ADHD focus on executive function development and STEM learning.

Referring now to the drawings in general, the illustrations are for the purpose of describing one or more preferred embodiments of the invention and are not intended to limit the invention thereto.

In one embodiment, the system of the present invention provides an automated executive function coaching platform. In one embodiment, the system of the present invention provides an automated STEM-subject coaching platform. In one embodiment, the system of the present invention provides an automated executive function and STEM-subject coaching platform. In one embodiment, the system of the present invention provides an automated motivational interviewing platform.

The system is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The system is operable to use any of the aforementioned learning techniques alone or in combination.

Further, the system is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The system is preferably operable to recommend and/or perform actions based on historical data, external data sources, ML, AI, NNs, and/or other learning techniques. The system is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

In one embodiment, the system of the present invention is operable to include an AI module. In one embodiment the AI module is operable to include a large language model (LLM). In one embodiment the AI module is operable to include a machine learning module. In one embodiment the AI module is operable to include a neural network model. In one embodiment the AI module is operable to include a deep learning model.

In one embodiment, the system of the present invention is operable to utilize a pre-trained AI module as the foundation of the AI module. In one embodiment, the pre-trained AI module is operable to undergo instruction and prompt training to produce an instruction-tuned custom AI module for the system of the present invention. In one embodiment, the pre-trained AI module includes a pre-trained open-source LLM. In one embodiment, the pre-trained LLM includes the Mistral 7B Instruct Model.

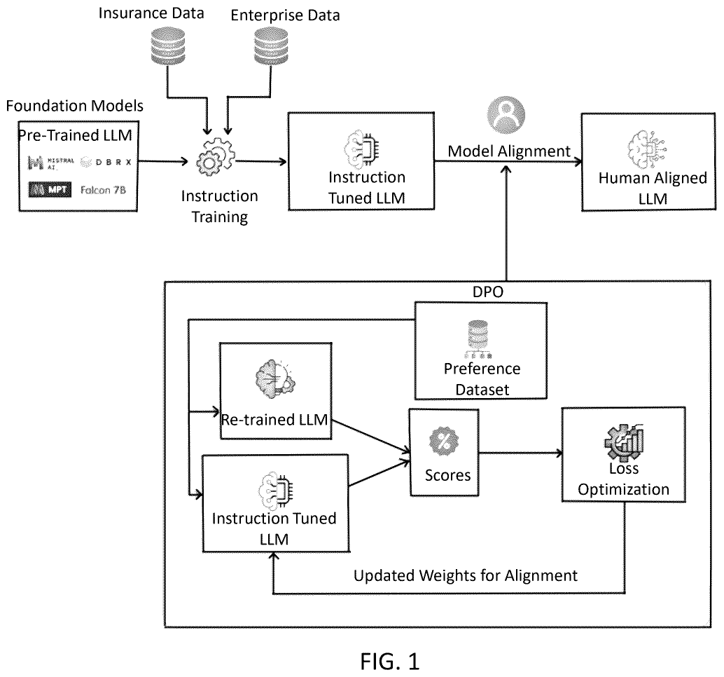

FIG. 1 is a is a block diagram of the steps performed by a system of the present invention for training an AI module according to one embodiment of the present invention. In one embodiment, the system of the present invention is operable to include a foundation model (i.e., a pre-trained AI module). In one embodiment, the pre-trained AI module is trained to produce an instruction-tuned custom AI module for the system of the present invention. In one embodiment, the system of the present invention is operable to train the pre-trained AI module with training materials including, executive function coaching manuals, executive function coaching workbooks, study-session planning documentations, neuroscience coaching manuals, ADHD manuals, behavior therapy training materials, assessments, monitoring data, general adolescence coaching materials, psychological assessments, teaching manuals, cognitive neuroscience subject matter, The CBT HANDBOOK, STEM subject materials, knowledge graphs, literature, publications, and/or any other related training materials. In one embodiment, the assessments used to train the pre-trained AI module include the Woodcock Johnson tests, the Wechsler Adult Intelligence Scale, Conners Continuous Performance Test, the Vanderbilt Assessment Scale, the Behavior Rating Inventory of Executive Function (BRIEF) assessment, self-assessments, and/or other standardized assessments. In one embodiment, real-time visuals of a bag and/or a room of a user is used to train the pre-trained AI module. In one embodiment, parent inputs, coaching logs and reports, real-time analytics on physiological data of at least one user, activity logs, screen time, clinical notes, academic reports, school assignments, homework log, and/or teacher reports of at least one user are used to train the pre-trained AI module of the present invention.

In one embodiment, the AI module is operable to utilize recorded simulated coaching sessions to further train the pre-trained AI module of the present invention. In one embodiment, certified expert coaches perform simulated coaching sessions with at least one student volunteer, wherein the simulated coaching session is recorded and reviewed by a licensed U.S. school psychologist, wherein the recording is analyzed to determine the performance of the AI module.

In one embodiment, the simulated coaching sessions are monitored by the AI module to detect learning issues, disengagement, and/or alertness. In one embodiment, the AI module is operable to utilize ambient listening tools to extract relevant data from conversations during the simulated coaching session. In one embodiment, the pre-trained AI module is operable to be trained on multiple cognitive neuroscience-based data modalities, including, through techniques such as self-supervised learning. In one embodiment, data modalities include images and data from parents, teachers, self-reports, formal academic reports, coaching logs, app activity logs, and/or other behavioral data can be paired with language data, including text and/or speech data.

In one embodiment, the AI module is operable to be refined with direct preference optimization (DPO), requiring evaluation from human participants. In one embodiment, the human participants include those with expertise in executive function coaching. In one embodiment, the human participants include those with expertise in child psychology. In one embodiment, the human participants include those with expertise in STEM learning methods. In one embodiment, the human participants include those with expertise in cognitive neuroscience. In one embodiment, the human participants include those with expertise in behavioral therapy. In one embodiment, the human participants include those with expertise in childhood development. In one embodiment, the system is operable to use DPO to optimize the AI module to generate outputs that are more aligned with human participant preferences.

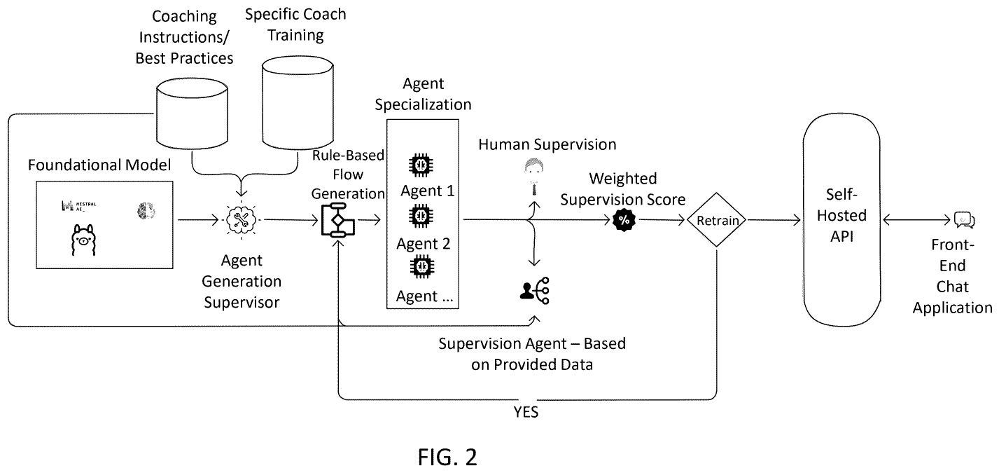

FIG. 2 is a is a block diagram of the steps performed by a system of the present invention for training an AI module according to one embodiment of the present invention. In one embodiment, the system of the present invention is operable to include at least two types of unstructured data, wherein the unstructured data is compiled into a repository. In one embodiment the at least two types of unstructured data include coaching instructions and best coaching practices from a plurality of executive function coaching manuals, and/or specific coach training, such as executive function coaching. In one embodiment, the system of the present invention is operable to include a foundational model (i.e., a pre-trained AI module), wherein the foundational model is operable to carry out a plurality of tasks.

In one embodiment, an agent generation supervisor includes a specialized, fine-tuned AI model that takes the unstructured data from the training and best practices and compiles the data into specific agents of the system. In one embodiment, the agents include a foundational model that has been trained using the training materials, written instructions for a task that the agent is operable to achieve, a written prompt persona that describes how the agent should act, and/or tools for the agent to use to accomplish the task, including document searches. In one embodiment, an agent is assigned to a single step in a rules-based flow with a corresponding tracking state assigned to the agent.

In one embodiment, at least one additional AI agent developed off of one of the foundational models is operable to engage in agent generation, wherein an “agent” represents a fine-tuned AI module that is specialized at a specific task or skill, such as in the context of coaching, probing questioning, and/or role playing, wherein the agent is given specific tools, such as web search and/or code validation, to accomplish the task.

In one embodiment, an agent developed off of at least one foundational model is operable to read the coaching instructions and develop a rules-based approach based on the coaching instructions, wherein the rules-based approach can be reviewed by a human.

In a preferred embodiment, one agent is assigned to each step in the rule-based flow. In one embodiment, at least one agent is shared across multiple steps. In one embodiment, a single step in the rules-based flow requires a multiplicity of agents.

In one embodiment, the rules-based flow generation includes rule-based structure of the coaching process, wherein a rules-based algorithm is deployed to determine the structure of a coaching session. In one embodiment, the rules-based structure of the coaching process includes the steps of the coaching process, compiled as instructions of what needs to be done at what step, rules to follow, and when to proceed to the next or retract to the previous step. In one embodiment, at least one agent developed off of one of the foundational models is operable to read the coaching instructions and develop a rules-based approach pursuant to the instructions.

In one embodiment, the coaching instructions are written as a series of step-by-step instructions. In one embodiment, the coaching instructions are written as alternate branches, including if/then statements. In one embodiment, the coaching instructions are formatted in a structured data output format, including JSON and/or XML. In one embodiment, the rules-based flow is reviewed by a human supervisor.

In one embodiment, the foundation model is operable to undergo agent generation supervision. In one embodiment, coaching instructions and/or specific coach training is combined with agent generation supervision to further train the foundation model. In one embodiment, an agent generation agent utilizes the training materials, including the structured and/or unstructured data, to create a supervisory agent, wherein the supervisory agent reviews the outputs of the finished coaching model and scores it against the standard put forth in the training materials. In one embodiment, the system is operable to perform test cases to be scored by the supervisory agent and/or a human supervisor, wherein the scoring occurs by reviewing the transcript of the model and a user and scoring whether the agent performs the specific tasks in the conversation on a numeric scale. In one embodiment, the scoring is conducted line-by-line. In one embodiment, the scoring is conducted for an entire transcript.

In one embodiment, a weighted supervision score is generated based on the supervisory agent supervision score. In one embodiment, a weighted supervision score is generated based on the human supervision score. In one embodiment, a weighted supervision score is generated based on both the supervisory agent score and the human supervision score. In one embodiment, an overall weighted supervision score is produced. In one embodiment, weighted sub-scores are produced for a plurality of categories.

In one embodiment, the weighted overall scores and/or the weighted sub-scores are compared against a series of numeric criteria to determine whether the model is acceptable or unacceptable to move to production and used. In one embodiment, the weighted overall score is compared against a target score and a minimally acceptable score, wherein if the weighted overall score does not meet the at least minimally acceptable score, the model will undergo retraining and will not be moved to production, wherein specific agents are operable to be identified that display the most errors, wherein the specific agents are operable to fine-tune the agent instructions. In one embodiment, if the weighted overall score meets the at least minimally acceptable score and/or the target score, the model will be pushed to production to begin use with human active users, wherein the model is further operable to be retrained into a next generation.

In one embodiment, the weighted sub-scores are compared against a single acceptable criterion, wherein if the weighted sub-scores are below the single acceptable criteria, the AI module will be rejected and retrained, wherein if the weighted sub-scores are above the single acceptable criteria, the model moves to production.

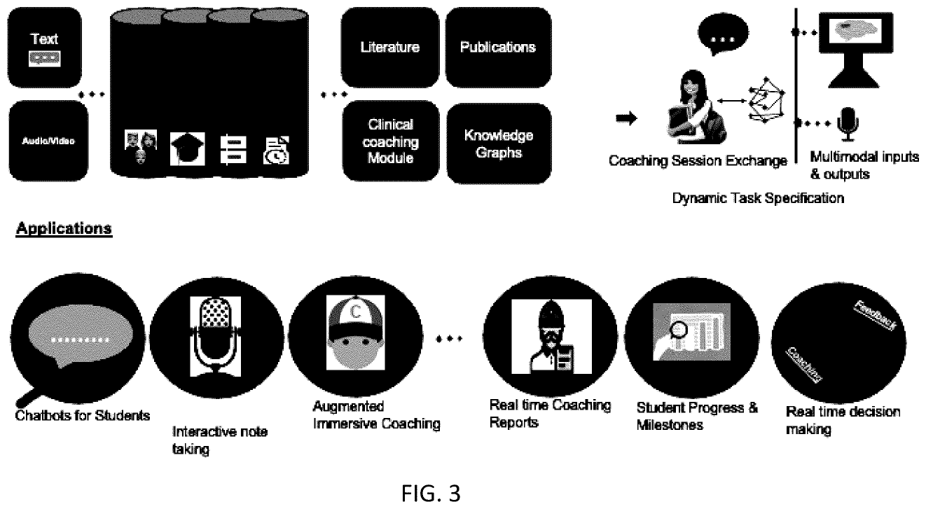

In one embodiment, the system of the present invention is operable to include an application programming interface (API). In one embodiment, the AI module moves to production via a self-hosted API, wherein the self-hosted API may be accessed via a built-in web application or opened to other applications as a white labeled service. In one embodiment, the system is operable to include a software development kit (SDK). In one embodiment, the system includes a front-end chat application. FIG. 3 illustrates an overview of an AI module of the present invention according to one embodiment of the present invention. In one embodiment, the AI module conducts coaching and/or specific reasoning tasks that users specify in real-time or near real-time. In one embodiment, the AI module retrieves contextual information from a plurality of sources, including knowledge graphs, databases, clinical coaching modules, and/or publications. In one embodiment, the AI module is operable to perform coaching sessions including multimodal inputs and outputs. The AI module is able to be used in a plurality of applications, including chatbots for students, interactive note taking, augmented immersive coaching, real-time or near real-time coaching reports, student progress and milestone reporting, and/or real-time or near real-time decision making.

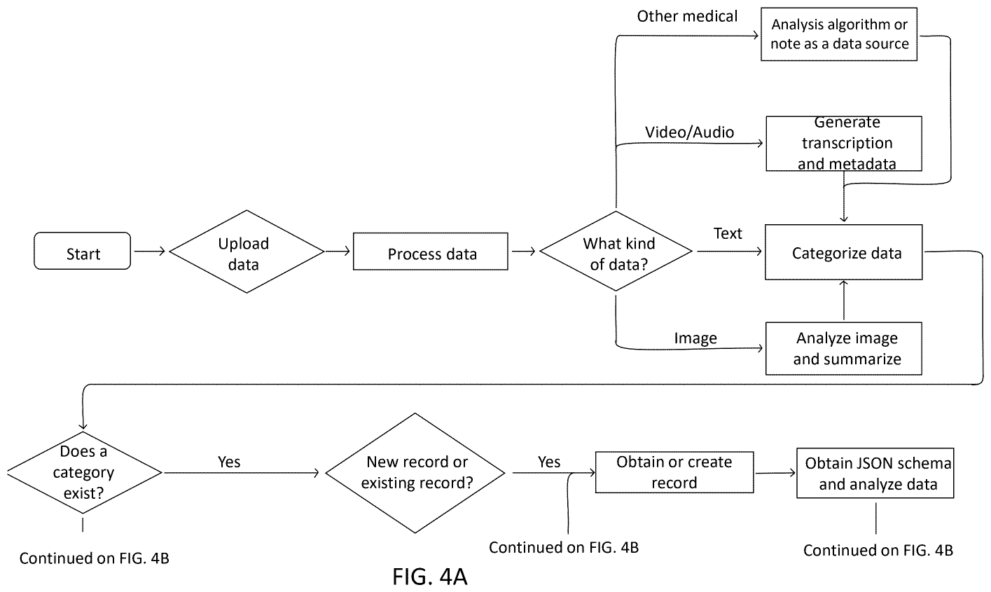

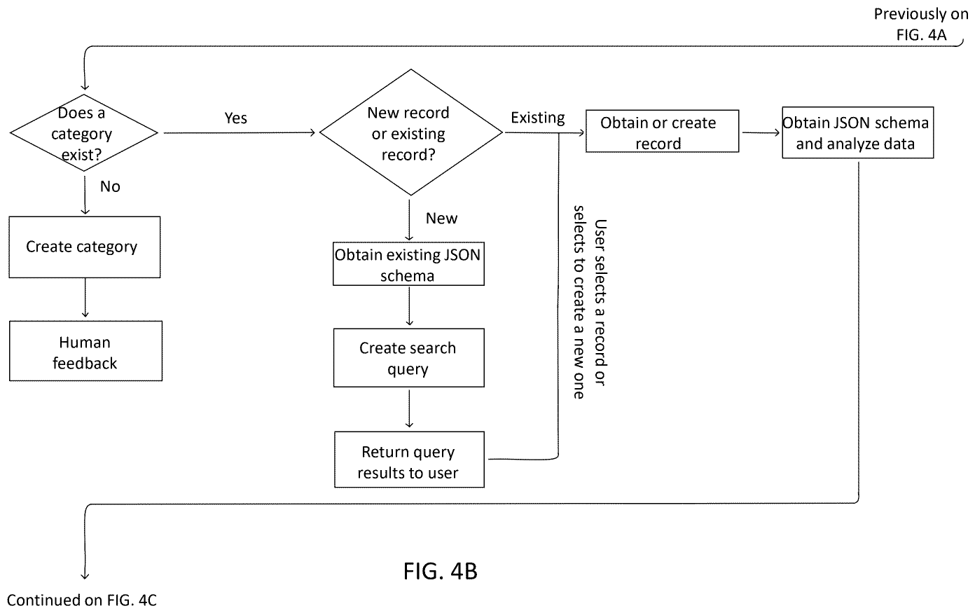

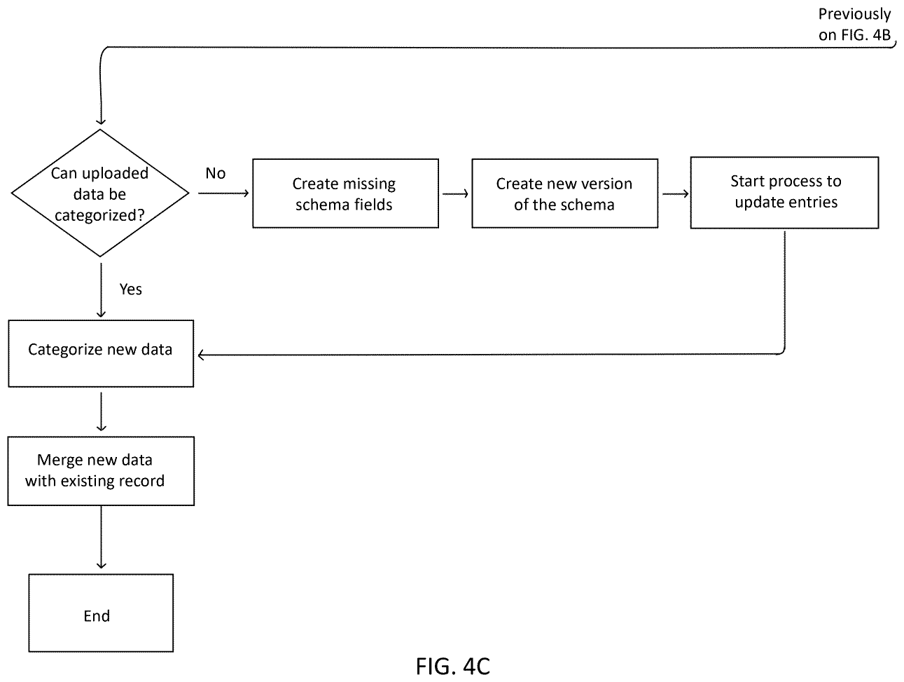

In one embodiment, the system of the present invention is operable to receive uploaded data. FIGS. 4A-4C illustrate a block diagram of the steps performed by a system of the present invention for uploading data according to one embodiment of the present invention. In one embodiment, the system is operable to receive and process data uploaded by at least one user. In one embodiment, the system is operable to determine the type of data the uploaded data is, including image, text, video, audio, medical, and/or other data. In one embodiment, the system is operable to analyze the uploaded data based on the type of data. In one embodiment, the system is operable to apply the appropriate analysis algorithm or note the data as a data source if the uploaded data includes other medial data, including scans. In one embodiment, the medical data includes general medical records, psychiatrist medical records, therapist and other medical professional's reports, medical assessments, inpatient hospitalization visits, emergency room visits, crisis center visits, discharge summaries, and/or medication lists. In one embodiment, the system is operable to generate a transcription and metadata from uploaded video and/or audio data. In one embodiment, the system is operable to analyze uploaded image data and generate descriptive summaries of the input image.

In one embodiment, the system is further operable to categorize the uploaded data. In one embodiment, the system is operable to categorize the uploaded data based on what the data relates to, such as patient, doctor, and/or other. In one embodiment, the system is operable to create a new category if one does not already exist. In one embodiment, the system is operable to create a new category by generating the category name and description, and further operable to request human feedback to ensure proper categorization. In one embodiment, an existing category exists, the system is operable to determine whether a user input identified a specific record for the data to be linked to or whether the user input indicated a request for a new record. In one embodiment, if the user input identified a specific record, the system is operable to obtain the identified record and/or create a new record from an existing data schema. In one embodiment, the system is further operable to utilize the AI model to determine if the uploaded data fits into an existing data schema. In one embodiment, if the uploaded data fits in an existing data schema, the system categorizes the uploaded data into the appropriate fields from the data schema, merges the new data with the existing record and saves the record to a database. In one embodiment, if the uploaded data cannot fit in an existing data schema, the system is further operable to use the AI module to create the missing data schema fields that match the uploaded data, wherein the system is further operable to create a new version of the data schema in its history, categorize the data into the appropriate fields, merge the new data with the existing record and save the record to a database.

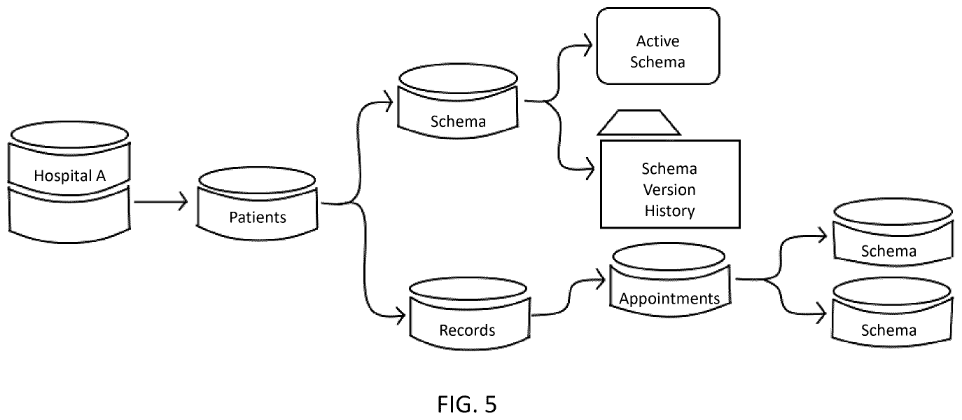

In one embodiment, the system of the present invention is operable to add new fields of data. FIG. 5 is a schematic diagram of a hierarchical database organization scheme according to one embodiment of the present invention.

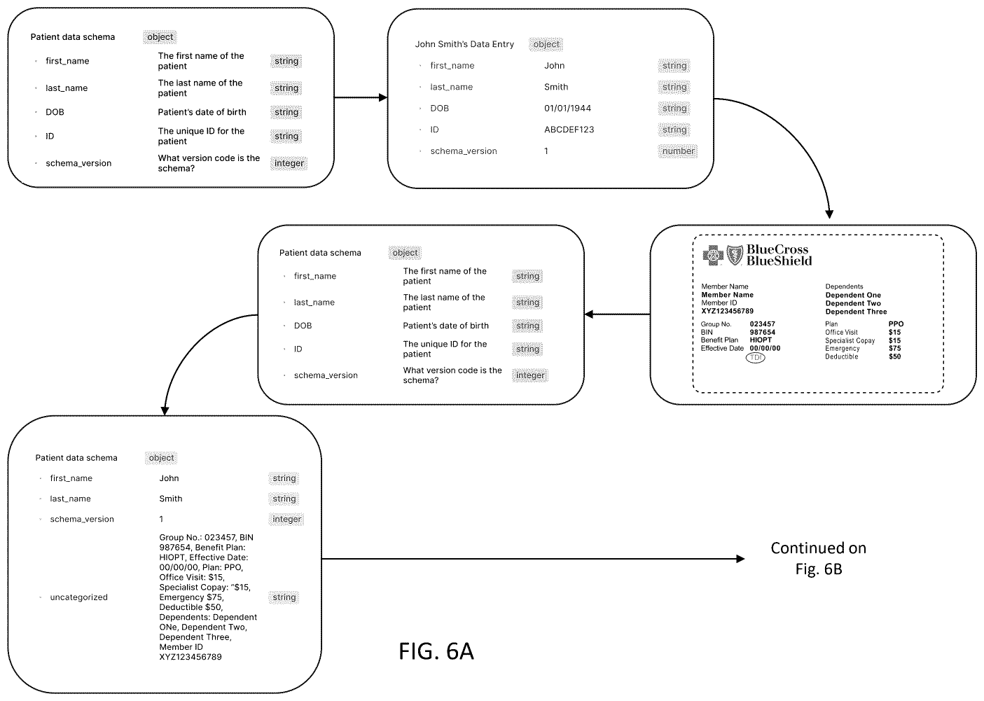

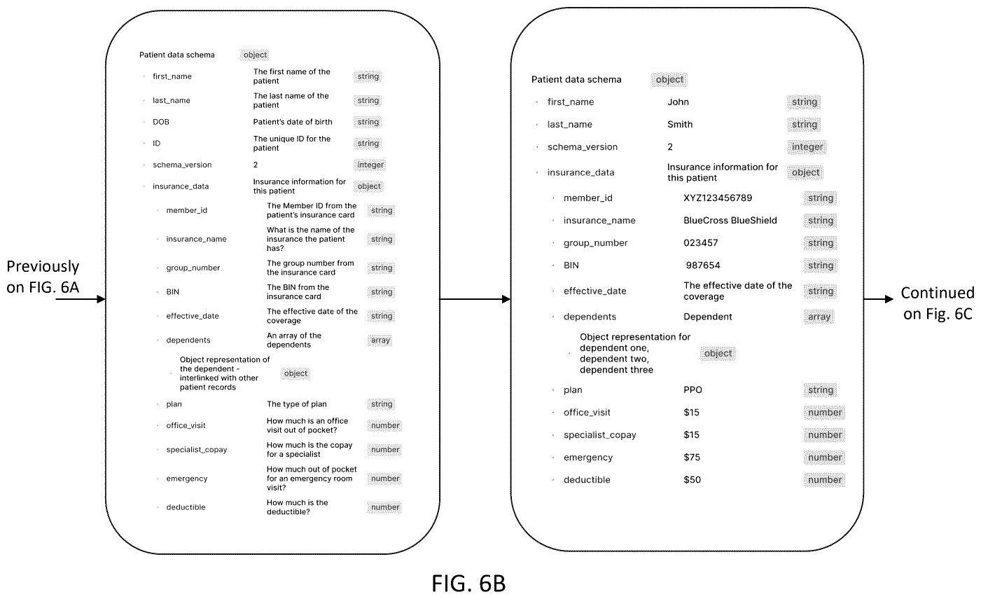

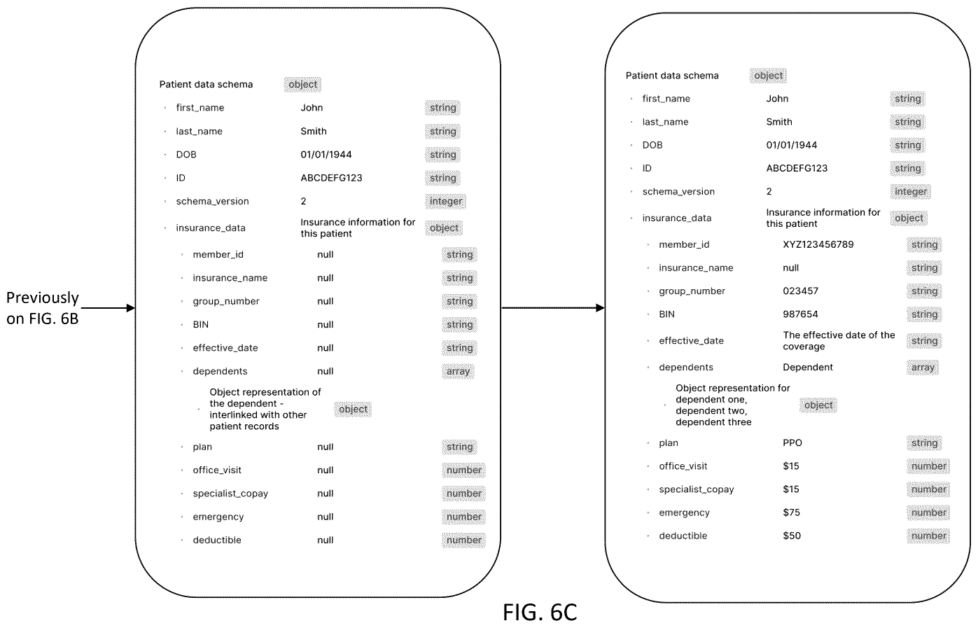

FIGS. 6A-6C illustrates a block diagram of the steps performed by a system of the present invention for adding new fields data according to one embodiment of the present invention. In one embodiment, the schema for patient data is one level deep with no linked or sub-records. In one embodiment, the schema for patient data includes a first name, a last name, a date of birth, a unique ID for the patient, and/or the version code of the schema. In one embodiment, the system is operable to receive an uploaded patient insurance card, wherein a preprocessing algorithm analyzes the image of the insurance card to extract text and other features. In one embodiment, the system is then operable to pass this new data to the categorization algorithm. In one embodiment, the categorization algorithm recognizes the category of the new data (insurance card) and pulls the category schema. In one embodiment, the categorizing algorithm is further operable to read the data provided from the image analysis and the schema, wherein the categorizing algorithm matches data from the analyzed image to fields in the schema. In one embodiment, if any data does not match, the input is designated as uncategorized and any fields in the schema that do not have appropriate data from the input get ignored. In one embodiment, the AI module is operable to receive the schema and uncategorized data, wherein the AI module is trained to generate updated schemas. In one embodiment, another algorithm of the system is operable to update all entries under the category to the newest version code. In one embodiment, the algorithm is operable to perform a query to determine the record of a patient. In one embodiment, the final data is saved to a patient record.

In one embodiment, the system is operable to perform a wide array of cognitive neuroscience tasks, including, the intelligent analysis of documents, the extraction of key information from executive function coaching manuals and workbooks, session-study planning documentation, treatment planning documents, service delivery documents, and/or chatbot question and answers.

In one embodiment, the system of the present invention includes an online platform. In one embodiment, the system of the present invention includes a mobile application. In one embodiment, the system is operable to be integrated with other mobile applications. In one embodiment, the system is operable to be integrated with a calendar or scheduling application, including GOOGLE CALENDAR, and/or word processing platform, including GOOGLE DOCS.

In one embodiment, the system is operable to receive a request from at least one user device (e.g., a mobile phone, a computer, a tablet, etc.) to create an account and/or user profile corresponding to one or more users. In one embodiment, the system is operable to create a new user profile. In one embodiment, the new user profile is created by at least one user, wherein the profile is created based on input from the at least one user. In one embodiment, the inputs to create the user profile includes account information identifying aspects of the user, including demographics, medical history, academic history, family history, background, social history, athletic history, goals, legal guardians, treatment team, and/or student history, user preferences, historical data for the user and/or other data. In one embodiment, user demographics include a name (e.g., first name, middle name, last name, nickname, username), a date of birth, a gender, an age, a race, an ethnicity, a physical address, at least one email address, at least one phone number, a grade range, a level of education, school, academic performance history, a primary reason for engagement, one or more additional authorized users with access to the account (e.g., a parent, a teacher, etc.), and/or other user preferences. In one embodiment, the at least one user profile includes at least one designated means of contact for recovering account information (e.g., at least one email address, at least one phone number, at least one linked social media account, etc.).

In one embodiment, the user goals include short term and long terms goals.

In one embodiment, the user's legal guardians and treatment team includes a legal guardian, academic coach, case manager, teacher, and/or psychiatrist of the user.

In one embodiment, the user history includes the user's background, reason for seeking services, academic history, accommodations, grades, classes, medical history, diagnosis and associated symptoms, medications, and/or any other interventions or treatments.

In one embodiment, the system is operable to create the user profile based on an associated social media account (e.g., FACEBOOK, INSTAGRAM, LINKEDIN, GMAIL, YOUTUBE, REDDIT, TWITTER, MYSPACE, TUMBLR, MASTODON, etc.). The system receives a selection of one or more social media platforms from a user device and initiates an application programming interface (API) call to verify that the user device being used to login is signed into an account on the selected one or more social media platforms on the user device. If no login using the associated social media account has previously been attempted, then the system automatically generates a user profile corresponding to the associated social media account. If an existing user profile exists corresponding to the associated social media account, then the system validates login into the existing user profile. This process is useful, as it allows a user to login and access the system without having to create a new username and password for the system. Furthermore, in one embodiment, the system is configured to automatically retrieve data corresponding to the associated social media account via at least API call to a database of the social media platform. In one embodiment, data retrieved via these means include bibliographical data (e.g., name, address, contact information, etc.) and/or preference data (e.g., estimated political views, estimated shopping preferences, estimated content preferences, etc.). In one embodiment, retrieved bibliographical data is used to automatically fill in information corresponding to the generated user profile on the system. In one embodiment, retrieved preference data is used to filter and select media displayed for the user profile on the system.

In one embodiment, the system is operable to create the user profile based on analysis of the academic history and academic profile of a user. In one embodiment, academic history includes identifying school information including school name, location, and/or contact information, level of education, terms attended, completed courses, in-progress courses, standardized test scores, final subject grades, academic standing, grade point average (GPA), academic rank, behavioral assessments, and/or disciplinary actions. In one embodiment, the AI module of the present system analyzes the academic history and academic profile of a user and generates a corresponding user profile.

In one embodiment, the system prompts the user device to register one or more items of biometric information to associate with the user profile. In one embodiment, the biometric information includes one or more fingerprints, one or more retinal scans, one or more facial scans, and/or one or more voice samples (e.g., for voice pattern analysis).

In one embodiment, the one or more of the user profiles is able to view information associated with the one or more other profiles or subprofiles (e.g., medical information, grades, activity performance stats).

In one embodiment, once the user profile is created, the system is operable to assess the user profile to determine the development level of the user and generate individualized coaching plans for the user. In one embodiment, the system is operable to assess the user profile to determine the development level of the user. In one embodiment, the system is operable to assess the development level of the user based on the user's interactions with the system, wherein at least one user interacts with the system, and wherein, during a user interaction the system is operable to receive inputs relating to the user's development level. In one embodiment, the system is operable to assess the academic history and academic profile of a user to determine the development level of the user.

In one embodiment, the system is operable to include assessments to determine a development level of a user. In one embodiment, the assessments include questionnaires, interviews, and/or other assessments. In one embodiment, the assessments are administered to the user through at least one user device. In one embodiment, the assessments are timed. In one embodiment, the assessments are not timed.

In one embodiment, the questionnaire includes at least one question. In one embodiment, the questionnaire includes a plurality of questions. In one embodiment, the questionnaire includes self-evaluating questions. In one embodiment, the questionnaire is based on a scale seven-point scale of 1-7. In one embodiment, the questionnaire is based on a five-point scale of 1-5. In one embodiment, the questionnaire is based on a ten-point scale of 1-10. In one embodiment, the questionnaire is based on a one-hundred-point scale of 1-100. In one embodiment, the questionnaire is based on a binary (e.g., thumbs up or thumbs down) scale. In one embodiment, the questionnaire is based on a descriptive scale. In one embodiment, the questionnaire is based on a nominal scale. In one embodiment, the questionnaire is based on an ordinal scale. In one embodiment, the questionnaire is based on a Likert scale. In one embodiment, the questionnaire is based on a semantic scale. In one embodiment, the questionnaire is based on a custom scale of the present system.

In one embodiment, the system is operable to receive input from a teacher, guardian, parent, case manager, and/or psychiatrist based on an interview with the user, wherein the teacher, guardian, parent, case manager, and/or psychiatrist asks the user questions and records the user's responses.

In one embodiment, the AI module is operable to conduct an interview of a user. In one embodiment, the AI module is operable to display interview questions on at least one user device. In one embodiment, the AI module is operable to record vocal responses of the user to the displayed interview questions. In one embodiment, the AI module is operable to perform voice analysis on the recorded vocal responses. In one embodiment, the AI module is operable to receive typed written descriptive answers to the interview questions. In one embodiment, the AI module is operable to analyze the recorded vocal response and/or written answers to determine the development level of a user.

In one embodiment, the interview includes a plurality of questions testing for metacognitive knowledge, skills and strategies, self-monitoring skills, and a level of self-awareness. In one embodiment, the interview includes a plurality of multiple-choice questions. In one embodiment, the interview includes a plurality of true or false questions. In one embodiment, the interview includes a plurality of fill-in-the-blank questions. In one embodiment, the interview further includes a plurality of open-ended questions, including, how often a student is tested, what type of tests the student is given, what study methods the student uses, how the student studies for a test, what the student's hardest subject is, and/or whether the student studies over time or the night before a test. In one embodiment, the AI module is operable to analyze the interview responses of a user and determine the development level of the user based on the user's responses.

In one embodiment, the other assessments include a diagnostic assessment to identify the current knowledge and skillsets of a user. In one embodiment, the other assessments include STEM-subject specific assessments. In one embodiment, the other assessments include questions to test for executive functions. In one embodiment, the other assessments include a plurality of multiple-choice questions. In one embodiment, the other assessments include a plurality of true or false questions. In one embodiment, the other assessments include a plurality of fill-in-the-blank questions. In one embodiment, the other assessments further include a plurality of open-ended questions. In one embodiment, the AI module of the present invention analyzes the recorded response of a user and grades the assessment, wherein the AI module is further operable to determine the development level of a user based on the assessment scores.

In one embodiment, the other assessments further include non-cognitive factors of success assessment. In one embodiment, the non-cognitive factors of success assessment include testing for non-cognitive challenges in academic behaviors, academic perseverance, academic mindsets, learning strategies, and/or social skills. In one embodiment, the non-cognitive factors of success assessment include a plurality of self-rating questions. In one embodiment, the non-cognitive factors of success assessment is based on a scale of 1-5. In one embodiment, the non-cognitive factors of success assessment is based on a ten-point scale of 1-10. In one embodiment, the non-cognitive factors of success assessment is based on a one-hundred-point scale of 1-100. In one embodiment, the non-cognitive factors of success assessment is based on a binary (e.g., thumbs up or thumbs down) scale. In one embodiment, the non-cognitive factors of success assessment is based on a descriptive scale. In one embodiment, the non-cognitive factors of success assessment is based on a nominal scale. In one embodiment, the non-cognitive factors of success assessment is based on an ordinal scale. In one embodiment, the non-cognitive factors of success assessment is based on a Likert scale. In one embodiment, the non-cognitive factors of success assessment is based on a semantic scale. In one embodiment, the non-cognitive factors of success assessment is based on a custom scale of the present system. In one embodiment, the three lowest scores of the non-cognitive factors of success assessment indicate the student's non-cognitive challenges.

In one embodiment, the system is operable to integrate physiological data of a user into a user profile. In one embodiment, the system is operable to utilize physiological data of a user in generating a course of treatment for the user. In one embodiment, physiological data from wearable sensors worn by an individual is incorporated into a user profile. In one embodiment, wearable sensors include smart watches, smart rings, or any other wearable technology which provides biometric measurements. In one embodiment, the wearable sensors further include a heart rate sensor, blood pressure sensor, electrocardiogramansor, pressure sensor, accelerometer sensor, fluid level sensor, body temperature sensor, galvanic skin response (GSR) sensor, respiratory rate sensor, and/or pulse oximeter sensor. In one embodiment, physiological data includes indications of stress, anxiety, relaxation, or excitement during a coaching session and/or assessment. For example, heart rate and/or heart rate variability (HRV) measurements are operable to be measured during a coaching session and/or assessment and stored in the user profile.

In one embodiment, the AI module is operable to analyze the biometric data of a user in relation to a coaching module, and/or a user's integrated calendar, wherein the AI module is further operable to determine correlations between the user's biological response to the coaching modules and/or any other events the user experiences.

### Coaching

In one embodiment, the AI module is operable to generate individualized coaching plans and modules for a user based on the assessed development level of the user. In one embodiment, the AI module is operable to generate individualized coaching plans in real-time or near real-time. In one embodiment, the coaching plans focus on executive function development of a user. In one embodiment, the coaching plans focus on a specific STEM subject. In one embodiment, the coaching plans focus on the weakest assessed subject and/or area of a user. In one embodiment, the coaching plans focus on a requested subject and/or area by the user. In one embodiment, the coaching plans focus on a requested subject and/or area by a parent, guardian, teacher, or case manager.

In one embodiment, the system is operable to provide automated coaching to a user through the AI module. In one embodiment, coaching plans include a plurality of programs, assessments, and activities. In one embodiment, the programs, assessments, and activities target executive function development of a user, a specific STEM subject, and/or a requested subject.

In one embodiment, the system is operable to integrate individualized coaching plans for synchronous delivery. In one embodiment, the system is operable to integrate individualized coaching plans for asynchronous delivery.

In one embodiment, the coaching includes motivational interviews. In one embodiment, the AI module is operable to perform motivational interviews with a user. In one embodiment, the motivational interviews include open-ended, closed, leading, probing, recall, process, rhetorical, divergent, funnel, evaluation, inference, comparison, application, problem-solving, affective, and/or structuring questions for the user to answer. In one embodiment, the AI module is operable to synthesize the conversational data from the motivational interview with a user. In one embodiment, the AI module is operable to generate responses to the answers of a user, wherein the responses are shown on the screen of at least one user device and/or is emitted as sound from the at least one user device. In one embodiment, the motivational interviews include affirmations to be made by the user.

In one embodiment, the system includes a plurality of assessments within a coaching module. In one embodiment, the system includes a plurality of assessments before a coaching module. In one embodiment, the system includes a plurality of assessments after a coaching module. In one embodiment, the system includes at least one assessment before a coaching module begins. In one embodiment, the system includes at least one interim assessment during a coaching session. In one embodiment, the system includes at least one assessment after the completion of a coaching module. In one embodiment, the system includes no assessments before, during, and/or after a coaching module.

In one embodiment, assessment results include a user's visual processing, processing speed, fluid reasoning, math fluency, comprehension knowledge, short term/working memory, visual processing, long-term memory, and/or auditory processing.

In one embodiment, assessment results are analyzed by the AI module on a learning behavior rating scale, wherein the skills of a user are rated as compared to other users of the same age and gender. In one embodiment, the learning behavior rating scale rates the skills of a user in nine areas, including, attention skills, memory skills, logic and reasoning skills, sensory motor skills, oppositional behavior, processing speed skills, auditory processing skills, visual processing skills, and/or work or academic skills. In one embodiment, the learning behavior rating scale is scored on the Learning Space Rating System scale, wherein a score above 10 indicates a possible problem area, a score above 15 indicates a likely problem area, and a score above 20 indicates a potentially significant problem area. In one embodiment, the learning behavior rating scale is scored on an executive skills rating scale, the Woodcock Johnson scale, the Wechsler Adult Intelligence Scale, the Conners Continuous Performance Test scale, the Vanderbilt Assessment Scale, the Behavior Rating Inventory of Executive Function (BRIEF) assessment scale, self-assessment scales, and/or other standardized assessment scales.

In one embodiment, the system is operable to generate a behavior rating inventory of executive functioning, wherein the behavior rating inventory of executive functioning provides an overview of a user's functioning across a plurality of areas, including social, academic, behavioral, and/or emotional. In one embodiment, the behavior rating inventory of executive functioning includes evaluating skills, including self-monitoring, emotional control, organization, emotional regulation, working memory, task monitoring, planning, task completion, and/or initiation.

In one embodiment, the system is operable to generate reports of the progress of a user. In one embodiment, the reports are based on the completed coaching modules by a user. In one embodiment, the reports are based on the results of assessments of a user before, during, or after the coaching modules. In one embodiment, the system is operable to generate reports of the progress of a user after at least one coaching module. In one embodiment, the system is operable to automatically generate a report of the progress of a user after the completion of at least one coaching module. In one embodiment, the system is operable to automatically generate a report of the progress of a user after the completion of a plurality of coaching modules. In one embodiment, the system is operable to automatically generate a report of the progress of a user on a set schedule, such as every week, every month, and/or every year. In one embodiment, the system is operable to generate a report of the progress of a user at the request of a user, parent, guardian, teacher, and/or case manager. In one embodiment, the system is operable to automatically send the report to a user's parent, guardian, teacher, and/or case manager.

In one embodiment, the AI module is operable to automatically generate lesson plans, wherein the lesson plans are the foundation and structure of the coaching modules. In one embodiment, the AI module is operable to automatically generate lesson plans based on assessments of a user. In one embodiment, the AI module is operable to automatically update the lesson plans based on the progress of a user. In one embodiment, the AI module is operable to update the lesson plans at least every academic term, including semester and/or year.

In one embodiment, the AI module is operable to generate session plans, wherein the session plans are the foundation and structure of a single coaching module. In one embodiment, the AI module is operable to generate session plans after the completion of a coaching module. In one embodiment, each individual coaching module has a corresponding session plan. In one embodiment, a session plan should be completed before, during, and/or after a coaching session.

In one embodiment, the system is operable to offer academic coach planning time, wherein the AI module is operable to offer solutions for subjects and/or areas that a user still needs improvement in after completing a coaching module.

In one embodiment, the AI module of the system of the present invention is operable to detect non-compliance and/or user dropouts by identifying patterns and anomalies in user usage data. In one embodiment, the AI module is operable to send an alert to a parent, guardian, teacher, case manager, and/or psychiatrist, if the AI module detects non-compliance or user dropout by a user. In one embodiment, the system is operable to allow a user to resume coaching where the user left off before dropout or non-compliance.

In one embodiment, the system integrates with a camera of a user device and uses principles of computer vision and gaze estimation to track user eye movements. In one embodiment, the AI module is operable to analyze tracked eye movement of a user to determine a user's attention to the coaching module and/or assessment.

In one embodiment, the system is operable to include voice identification, wherein a user's voice is recorded by the system. In one embodiment, the AI module is operable to analyze the recorded user's voice and determine a user's attention and interest to the coaching module and/or assessment.

### Coaching Programs and Activities

In one embodiment, coaching plans include a plurality of programs, assessments, and activities.

In one embodiment, the system is operable to provide a plurality of different programs, including executive function coaching, Cogfit, stand-alone programs, college training, and/or adult training.

In one embodiment, the Cogfit program is based on a Cogfit manual, wherein the Cogfit manual includes cognitive training information and resources. In one embodiment, the Cogfit program includes at least one session. In a preferred embodiment, the Cogfit program includes five hours per week of sessions.

In one embodiment, the executive function coaching includes at least one session. In a preferred embodiment, the executive function coaching includes two sessions per week, each session lasting for at least one hour.

In one embodiment, the stand-alone programs include study skills, test preparation, reading fluency, algebra readiness, and/or writer's workshop programs.

In one embodiment, the college and/or adult coaching includes college readiness, picking a college, picking a major, and/or college applications.

In one embodiment, the system is operable to include a plurality of activities. In one embodiment, the plurality of activities corresponds to the eleven executive functions. In one embodiment, the plurality of activities is grouped based on the eleven executive functions. In one embodiment, the plurality of activities includes emotional control activities, sustained attention activities, response inhibition activities, working memory activities, task initiation activities, cognitive flexibility activities, organization activities, planning and prioritization activities, time management activities, goal-directed persistence activities, and/or metacognition activities.

In one embodiment, the plurality of activities includes web-based and print-based activities. In one embodiment, the web-based activities are operable on a plurality of online browsers, WINDOWS, MAC, and/or mobile applications. In one embodiment, the print-based activities are operable to be physically printed from the system. In one embodiment, the print-based activities are operable to be digitally completed or written on via a user device. In one embodiment, the plurality of activities includes activities from a plurality of sources, wherein external sources can be integrated into the system.

In one embodiment, the emotional control activities include web-based activities, including, LIVE HAPPY, SMILING MIND, POSITIVE PENGUINS, EMOTIONARY, and/or MIDDLE SCHOOL CONFIDENTIAL. In one embodiment, the emotional control activities include print-based activities, including you create the scenarios, break it down, emotional check-in, and/or what's your take.

In one embodiment, the sustained attention activities include web-based activities, including, STAYFOCUSED, WUNDERLIST, LUMOSITY, and/or FOCUS BOOSTER. In one embodiment, the sustained attention activities include print-based activities, including, y-chart, strengths-weaknesses-opportunities-threats (SWOT) Chart, and/or self-monitoring checklists.

In one embodiment, the response inhibition activities include web-based activities, including EDUCATION. COM and/or ILLINOIS EARLY LEARNING PROJECT. In one embodiment, the response inhibition activities include print-based activities, including reaction flow charts, y-charts, six pictures, and/or this caused.

In one embodiment, the working memory activities include web-based activities, including, LUMOSITY, BRAIN TRAINER SPECIAL, BRAIN FITNESS PRO, COGNIFIT BRAIN FITNESS, FIT BRAIN TRAINER, and/or GOOGLE CALENDAR. In one embodiment, the working memory activities include print-based activities, including, compare/contrast bubble maps, the 5 W's and how, organize the facts, process steps, reference citations, think-pair-share, and/or tips to improve memory.

In one embodiment, the task initiation activities include web-based activities, including, NUDGE, BUGME, CAN PLAN, ITS DONE, REMEMBER THE MILK, PLAN IT DO IT CHECK IT OFF, and/or TOODLEDO. In one embodiment, the task initiation activities include print-based activities, including, raindrop map, power triangle, concept/event maps, cycle of events, and/or the 5 W's and how.

In one embodiment, the cognitive flexibility activities include web-based activities, including, BRAIN TRAINER, LUMOSITY, AND/OR BRAIN HQ. In one embodiment, the cognitive flexibility activities include print-based activities, including change my thinking, make another plan, am I a flexible thinker, and/or growth minded.

In one embodiment, the organization activities include web-based activities, including, COLORNOTE, COZI, NOTESUITE, POCKET LISTS, 52 ORGANIZATION MISSIONS, CAREZONE, NOTABILITY, free graphic organizers, written expression organization, DROPBOX, and/or GOOGLE DOCS. In one embodiment, the organization activities include print-based activities, including problems and solution chains, a decision-making diagram, a homework checklist, a chore chart, a night before school checklist, CORNELL notetaking, lines tables, the frame organizer, and/or personalized POST-IT NOTES.

In one embodiment, the planning and prioritization activities include web-based activities, including, BEGIN, GTASKS, TASKS N TODOS, and/or PRIORITIZE ME. In one embodiment, the planning and prioritization activities include print-based activities, including, glance at the week, timeline, 3-2-1 notes, step process charts, hourly planner, problem solution organizer, decision chart, prioritizing sheet, five-day study plan, to-do lists, long term project planning sheet, template for five paragraph essays, and/or recommendations for studying for tests.

In one embodiment, the time management activities include web-based activities, including INCLASS, TICK TICK, TIMEFUL, RESCUE TIME, TIME PLANNER, and/or TOGGL. In one embodiment, the time management activities include print-based activities, including, how well do you plan, time order chart, self-monitoring sheet, time management, Covey's Time Management Grid, long term planner, and/or study log.

In one embodiment, the goal-directed persistence activities include web-based activities, including, NOZBE, HABITBULL, IRUNURUN, PLEDGE, STRIDES, and/or HABIT LIST. In one embodiment, the goal-directed persistence activities include print-based activities, including goals, weekly plan at a glance, grading period goals, focused project planner, SMART goal setting, WHEEL OF LIFE, and/or setting goals.

In one embodiment, the metacognition activities include web-based activities, including, a book creator, EDUCREATIONS interactive whiteboard, EXPLAIN EVERYTHING, and/or SHADOW PUPPET EDU. In one embodiment, the metacognition activities include print-based activities, including, the three point approach, question answer detail, question prompts, and/or clunks and clues.

One of ordinary skill in that art will understand that one or more of the above-mentioned activities are examples and not exclusive, provided to serve the purpose of clarifying the aspects of the invention, and it will be apparent to one skilled in the art that they do not serve to limit the scope of the invention.

### Gamification

In one embodiment, the system is operable to include gamification of coaching modules to incentivize users and enhance user engagement and retention. In one embodiment, a user can unlock rewards by successfully completing a coaching module and/or a game. In one embodiment, the rewards include monetary-based rewards such as gift cards.

In one embodiment, the system is operable to select a game based on the user's development level. In one embodiment, the system is operable to select a game based on a user's preference. In one embodiment, the system is operable to select a game based on the user's past performance. In one embodiment, the system is operable to allow a user to select a game. In one embodiment, the system is operable to select a game based on the user's grade level in school. In one embodiment, the system is operable to select a game based on the user's age. In one embodiment, the system is operable to select a game based on teacher, guardian, or case manager recommendations. In one embodiment, the system is operable to allow a user, teacher, guardian, parent, and/or case manager to override the game choice and select a different game.

In one embodiment, a user plays a game selected by the system. In one embodiment, after the user completes a game, the system is operable to determine an area in which the user has improved based on the gameplay. In one embodiment, after the user completes the game, the system is further operable to calculate the need for further development of a particular skill set. In one embodiment, the system is further operable to reward the user with rewards and recognition of improvement for the area the user has improved in. In one embodiment, the system is operable to recommend another game or additional content to assist the user with development of a particular skill set. In one embodiment, the system is operable to recommend additional activities and/or coaching to assist the user with the development of a particular skill set. In one embodiment, the system is operable to report the user's gameplay to a teacher, parent, guardian, case manager, and/or psychiatrist.

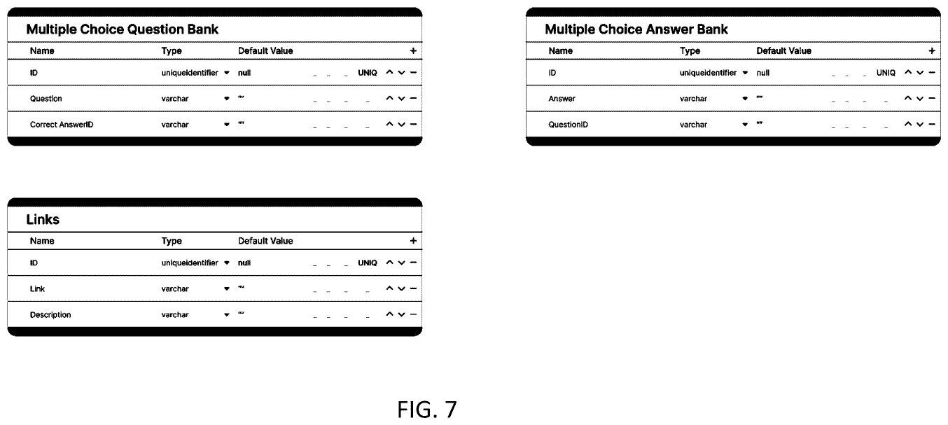

FIG. 7 illustrates the data structure of an assessment of the system of the present invention according to one embodiment of the present invention. In one embodiment, an assessment is generated based on each coaching module. In one embodiment, an assessment is based on an evaluation to consent concept to determine if a user understands the coaching sessions.

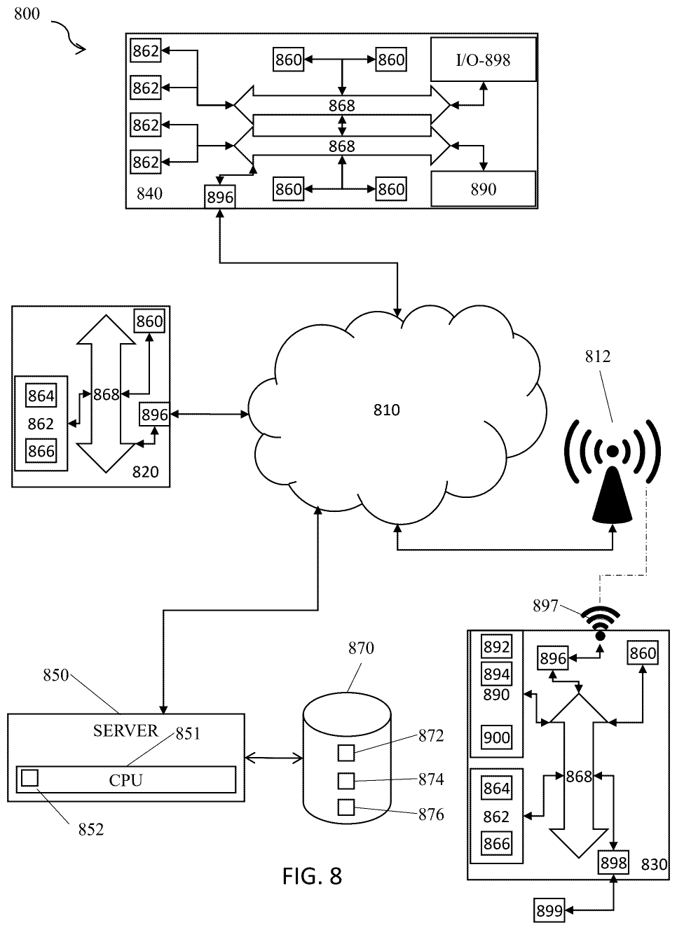

FIG. 8 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 8, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 8, is operable to include other components that are not explicitly shown in FIG. 8, or is operable to utilize an architecture completely different than that shown in FIG. ##. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for automated executive function coaching comprising:
a remote server including at least one computer processor and a memory;
a foundational artificial intelligence (AI) module;
a customized AI module; and
a user device;
wherein the foundational AI module is a pre-trained AI module, wherein the foundational AI module is operable to be further trained with training data, wherein the customized AI module is generated based on the further training of the foundational AI module;
wherein the customized AI module is operable to conduct an assessment of at least one user, wherein the assessment is administered through the user device, wherein the assessment includes at least one question;
wherein the customized AI module is operable to automatically analyze results of the assessment of the at least one user, wherein the customized AI module is operable to generate a score the results of the assessment, wherein the customized AI module is further operable to determine a development level of the at least one user based on the score of the results of the assessment;
wherein the customized AI module is operable to automatically generate an individualized coaching plan for the at least one user based on the results of the assessment of the at least one user; and
wherein the customized AI module is operable to conduct at least one coaching session through the user device, wherein the at least one coaching session includes at least one of a program, an assessment, and/or an activity, wherein the program, the assessment, and/or the activity is directed to executive function development of the at least one user.

2. The system of claim 1, wherein the customized AI module is operable to automatically generate at least one report concerning progress through the at least one coaching session of the at least one user.

3. The system of claim 1, wherein the customized AI module is operable to be trained with recorded simulated coaching sessions.

4. The system of claim 1, wherein the customized AI module is operable to be refined with direct preference optimization (DPO).

5. The system of claim 1, wherein the system further includes a supervisory artificial intelligence (AI) agent, and wherein the supervisory AI agent is operable to review an output of a finished coaching session and produce a score of the finished coaching session.

6. The system of claim 1, wherein the system is operable to receive and process data uploaded by from the user device.

7. The system of claim 1, wherein the customized AI module is operable to automatically generate a lesson plan based on the assessment of the at least one user, wherein the lesson plan is used in the at least one coaching session.

8. The system of claim 1, wherein the at least one coaching session further includes at least one game.

9. A method for automated executive function coaching comprising:
training a pretrained foundational artificial intelligence (AI) module with training data;
forming a customized AI module by the training of the foundational AI module;
conducting an assessment of at least one user by the customized AI module through a user device, wherein the assessment includes at least one question;
automatically analyzing results of the assessment of the at least one user by the customized AI module;
generating a score of the results of the assessment of the at least one user by the customized AI module;
determining a development level of the at least one user based on the score of the assessment by the customized AI module;
automatically generating an individualized coaching plan for the at least one user based on the results of the assessment by the customized AI module; and
conducting a coaching session through a user device by the customized AI module, wherein the coaching session includes at least one of a program, an assessment, and/or an activity, and wherein the program, the assessment, and/or the activity is directed to executive function development of the at least one user.

10. The method of claim 9, further comprising the customized AI module automatically generating at least one report concerning progress through the at least one coaching session of the at least one user.

11. The method of claim 9, further comprising training the customized AI module with recorded simulated coaching sessions.

12. The method of claim 9, further comprising refining the customized AI module with direct preference optimization (DPO).

13. The method of claim 9, further comprising a supervisory AI agent reviewing an output of a finished coaching session and producing a score of the finished coaching session.

14. The method of claim 9, further comprising receiving and processing data uploaded from the user device.

15. The method of claim 9, further comprising the customized AI module automatically generating a lesson plan based on the assessment of the at least one user, wherein the lesson plan is used in the coaching session.

16. A system for automated executive function coaching comprising:
a remote server including at least one computer processor and a memory;
a foundational artificial intelligence (AI) module;
a customized AI module; and
a user device;
wherein the foundational AI module is a pre-trained AI module, wherein the foundational AI module is operable to be further trained with training data, wherein the customized AI module is generated based on the additional training of the foundational AI module;
wherein the system is operable to receive and process data uploaded from the user device;
wherein the customized AI module is operable to conduct an assessment of the at least one user, wherein the assessment is administered through the user device, wherein the assessment includes at least one question;
wherein the customized AI module is operable to automatically analyze results of the assessment of the at least one user, wherein the customized AI module is operable to generate a score of the results of the assessment, wherein the customized AI module is further operable to determine a development level of the at least one user based on the score of the results of the assessment;
wherein the customized AI module is operable to automatically generate an individualized coaching plan for the at least one user based on the results of the assessment of the at least one user;
wherein the individualized coaching plan includes at least one lesson plan, wherein the at least one lesson plan is used in at least one coaching session; and
wherein the customized AI module is operable to conduct the at least one coaching session through the user device, wherein the at least one coaching session includes at least one of a program, an assessment, an activity, and/or a game, wherein the program, the assessment, the activity, and/or the game is directed to executive function development of the at least one user.

17. The system of claim 16, wherein the system is operable to receive visual data from a camera of the user device, wherein the system is operable to track eye movements of the at least one user based on the visual data.

18. The system of claim 16, wherein the customized AI module is operable to automatically generate at least one report concerning progress through the at least one coaching session of the at least one user.

19. The system of claim 16, wherein the system further includes a supervisory AI agent, and wherein the supervisory AI agent is operable to review an output of a finished coaching session and produce a score of the finished coaching session.

20. The system of claim 16, wherein the customized AI module is operable to be refined with direct preference optimization (DPO).
